(19) United States
(12) Patent Application Publication
(10) Pub. No.: US 2025/0355789 A1
(43) Pub. Date: Nov. 20, 2025

(54) MULTI-TIER MODULAR USER INTERFACE DESIGN AND TESTING

(71) Applicant: Synchrony Bank, Stamford, CT (US)

(72) Inventor: Matthew Rehkopf, Stamford, CT (US)

(21) Appl. No.: 19/206,144

(22) Filed: May 13, 2025

Related U.S. Application Data
(60) Provisional application No. 63/648,507, filed on May 16, 2024.

(51) Int. Cl. G06F 11/3668; G06F 11/34

(52) U.S. Cl. CPC G06F 11/3688; G06F 11/3419

(57) ABSTRACT

An interface testing system may generate user interfaces. A set of the user interfaces may be associated with a unique configuration of interface elements. The interface testing system may generate first feedback data by evaluating the set of user interfaces against first testing metrics. The first feedback data may indicate a first measure of performance of a respective user interface based on the first testing metrics and identify a subset of user interfaces based on the first feedback data. The interface testing system may generate second feedback data by evaluating the subset of user interfaces against second testing metrics. The second feedback data may indicate a second measure of performance of a respective user interface based on the second testing metrics and identify a preferred user interface of the subset of the user interfaces based on the second feedback data. The interface testing may implement the preferred user interface.

### CROSS REFERENCE TO RELATED APPLICATIONS

This application claims priority to U.S. Patent Application 63/648,507, filed May 16, 2024, entitled “MULTI-TIER MODULAR USER INTERFACE DESIGN AND TESTING,” which is incorporated by reference herein in its entirety.

### FIELD OF THE DISCLOSURE

The present disclosure relates to network data communications, data security, and user interfaces for sensitive information. Some examples particularly use modular user interface elements with testing of multiple user interface organizations to improve device operation with improve user interfaces.

### BACKGROUND

Users often use networks and associated computing devices to transmit, receive, store, and manage secure data, such as personal identifying information (e.g., government issued identifiers, financial data, or other such sensitive information). Such sensitive data can be used with a network when a network user, for example, seeks to obtain credit from a lending institution for a variety of purposes, such as purchasing a home, a car, or a business. Adding security to options for accessing or applying for such credit can create barriers to transactions between users, merchants, and lenders. When a decision is made by a lending institution to extend credit to a user, the creditworthiness of the user may be assessed using a multitude of scores, rules, signals, and thresholds. These sets of available credit scores and algorithms focus on the probability of repayment if the user borrows money. The data used in such decisions can be subject to a variety of privacy and regulatory considerations. Such considerations can further create barriers in the context of network communications and data management in a communication system for the data used to facilitate lending options and associated purchase transactions.

### SUMMARY

Methods and systems are described herein for testing modular user interfaces. An interface testing system may generate user interfaces to facilitate secure communications between a user device and an authentication system. At least a set of the user interfaces may be associated with a unique configuration of interface elements. The interface testing system may generate first feedback data by evaluating the set of user interfaces against first testing metrics. The first feedback data may indicate a first measure of performance of a respective user interface based on the first testing metrics. The interface testing system may identify a subset of user interfaces based on the first feedback data. The interface testing system may generate second feedback data by evaluating the subset of user interfaces against second testing metrics. The second feedback data may indicate a second measure of performance of a respective user interface based on the second testing metrics. The interface testing system may identify a preferred user interface of the subset of the user interfaces based on the second feedback data. The interface testing may implement the preferred user interface for use in secure data flows for network data management.

Systems are described herein for testing modular user interfaces. The systems include one or more processors and a non-transitory computer-readable storage medium storing instructions that, when executing by the one or more processors, cause the one or more processors to perform any of the methods as previously described.

A non-transitory computer-readable medium described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

FIG. 1 is a block diagram of a system in which network data management is performed according to some aspects of the present disclosure.

FIG. 2 illustrates aspects of data flow for network data management according to some aspects of the present disclosure.

FIG. 3 illustrates aspects of data flow for network data management according to some aspects of the present disclosure.

FIG. 4 illustrates aspects of data flow for network data according to some aspects of the present disclosure.

FIG. 5 illustrates aspects of data flow for network data management according to some aspects of the present disclosure.

FIG. 6 illustrates aspects of data flow for network data management according to some aspects of the present disclosure.

FIG. 7 illustrates aspects of data flow for network data management according to some aspects of the present disclosure.

FIGS. 8A-C illustrate aspects of modular user interfaces for use in secure data flows for network data management according to some aspects of the present disclosure.

FIGS. 9A-C illustrate aspects of modular user interface testing according to some aspects of the present disclosure.

FIG. 10 illustrates examples of modular user interfaces for use in secure data flows for network data management according to some aspects of the present disclosure.

FIG. 11 shows an illustrative system for network data management and communications with client and application systems according to some aspects of the present disclosure.

FIG. 12 shows aspects of a link generator and response system for use as part of a network data management system according to some aspects of the present disclosure.

FIG. 13 illustrates an example flow chart for testing different organizations or structures of modular user interfaces according to some aspects of the present disclosure.

FIG. 14 shows a computing system architecture including various components in electrical communication with each other using a connection in accordance with various embodiments.

### DETAILED DESCRIPTION

In the following description, for the purposes of explanation, specific details are set forth in order to provide a thorough understanding of certain inventive embodiments. However, it will be apparent that various embodiments may be practiced without these specific details. The FIGs. and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Certain network systems, such as those involved in financial and credit transactions, are subject to significant privacy and security concerns. Management of data in such networks have additional considerations beyond simple transmission of data, including fraud and regulatory considerations. Additionally, user interface elements for interacting with such systems can create friction and barriers to user interactions with the system, particularly when complex security and privacy systems are involved.

Aspects described herein include descriptions of modular architectures for user interfaces, and systems for testing different organizations or structures using such modular architectures. Such testing can be used to identify user interface improvements associated with device operation that may not be readily apparent during initial design and placement of elements within a user interface. Additionally, as indicated above, different user interface elements or flows may be modified in ways that increase the complexity of user interactions to address privacy and security concerns without initial considerations for the impacts on user engagement and system performance goals (e.g., added friction causing users to abandon system use or interact with a system in ways that do not match system goals). Aspects described herein improve the operation of networks and devices for use in payment systems by supporting additional functionality (e.g., privacy, security, dynamic modification, management of personal identification information (PII) and payment card industry (PCI) data, etc.), while managing the impacts of system changes and complexity on device usage (e.g., reducing the time needed for a device or system to perform system tasks or provide data to users, etc.).

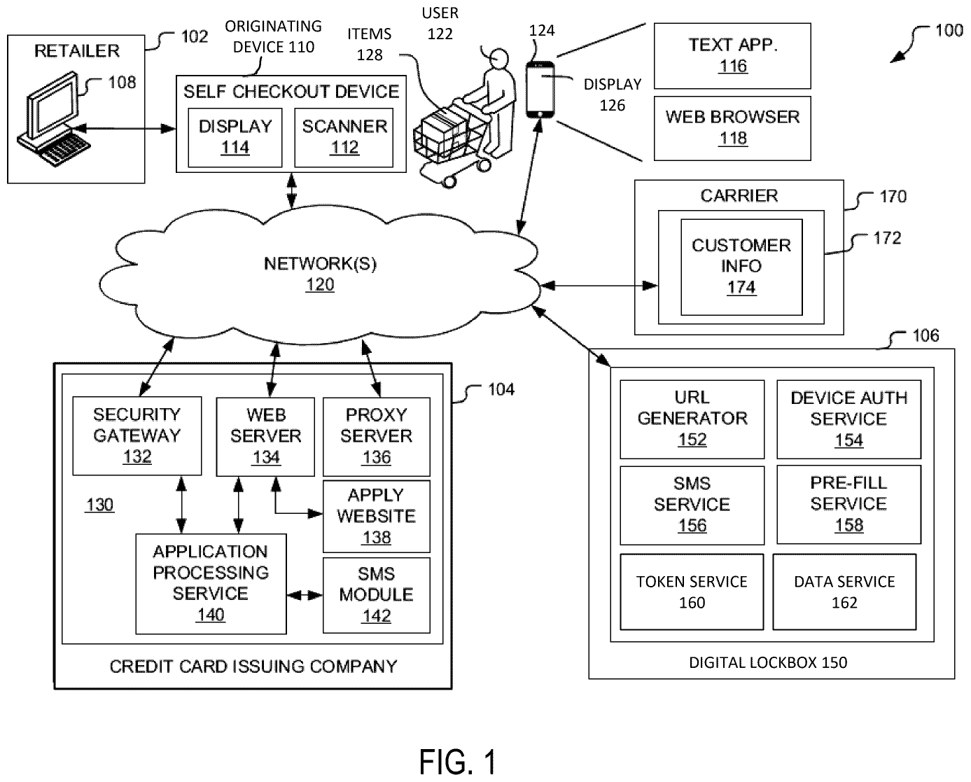

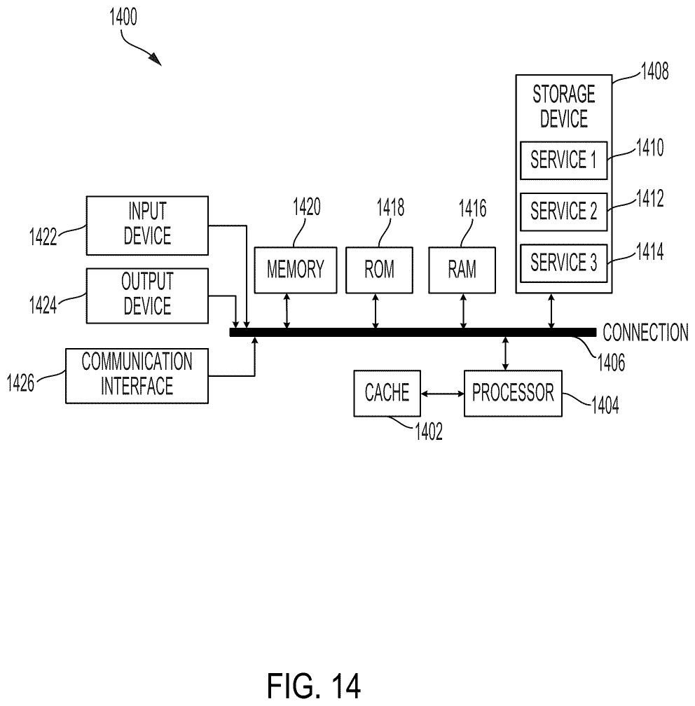

FIG. 1 is a block diagram of a system 100 in which network data management is performed in accordance with some examples. Multiple devices in system 100 can include user interfaces designed and tested in accordance with aspects described herein, including originating device 110, user device 124, or other such devices. The example system 100 includes a retailer 102, an account issuing system 104, and an authentication entity 106. In some systems, aspects can be merged, such as for example, the authenticating entity 106 being merged with the credit issuing system 104 such that devices of entity 106 and system 104 can be the same device or devices. The retailer 102 (e.g. a merchant or other client of authentication entity 106) includes a retail computing system 108 connected to at least one checkout register or device 110. The illustrated originating device 110 includes a scanner 112 (e.g., a barcode scanner) and a display 114. Other implementations can include a magnetic strip scanner or other payment input, a keypad, or other such elements. Additional examples of an originating device can be a tablet device, a smartphone, a laptop computer, or any other such device that can be accessed by a user, either directly, or through an employee of the retailer. The retail computing system 108 may be directly connected or connected by one or more networks 120 (described below) to the originating device 110. The retail computing system 108 and the originating device 110 may each be implemented by one or more computing devices, which may each be implemented as a computing device with architecture 1400 described below and illustrated in FIG. 14.

Referring to FIG. 1, the originating device 110 is configured to be operated by a user 122 having a user device 124 (e.g., a cellular telephone) with a display 126 (e.g., a conventional touch screen). For example, the user 122 may purchase one or more items 128 using the originating device 110. As will be described below, the user 122 may also use the originating device 110 and the mobile device 124 to apply for credit. Enabling the user 122 to request credit at the originating device 110 and complete the application process using the mobile device 124 gives the user 122 the opportunity to save money or make flexible financial arrangements by applying for credit when it is needed in a quick and easy manner. The user device 124 can access various communication channels, including short message service (SMS), text, application-based communications, e-mail, web browsers, or other such communication channels.

Referring to FIG. 1, mobile services are provided to the mobile device 124 by a mobile service provider or carrier 170. The carrier 170 operates one or more computing devices 172 configured to communicate over the network(s) 120. The computing device(s) 172 may each be implemented as the computing device with architecture 1400 described below and illustrated in FIG. 14.

The issuing system 104 operates one or more computing devices 130. The computing device(s) 130 implement a security gateway 132, a web server 134, a proxy server 136, an application processing service 140, and a SMS module 142. The security gateway 132 is configured to communicate with the SCO device 110 over the network(s) 120. The web server 134 and the proxy server 136 are both connected to the network(s) 120. The web server 134 is configured to generate an apply website 138. The application processing service 140 is configured to communicate with the security gateway 132 and/or the web server 134. The SMS module 142 is configured to communicate with the application processing service 140. The SMS module 142 may be implemented by middleware. By way of a non-limiting example, the computing device(s) 130 may each be implemented as the computing device 1400 described below and illustrated in FIG. 14.

The authentication entity 106 operates a digital lockbox 150 which can function as a repository of secure data that can be accessed using tokenized security interactions. The digital lockbox 150 can, in various examples, store sensitive data as part of data service 162. Interactions with the sensitive data of data service can be associated with unique tokens and/or unique single use Uniform Resource Locators (URLs). As described herein, tokenization combined with direct interaction of user devices 124 with the digital lockbox 150 provides enhanced functionality, security, and user privacy in different implementations.

Authentication entity 106 can operate one or more computing devices as part of digital lockbox 150 configured to communicate over the network(s) 120. The authentication computing device(s) of digital lockbox 150 may implement a generator 152, a device authentication service 154, an SMS service 156, a pre-fill service 158, a token service 160, and/or other similar services. By way of a non-limiting example, the authentication computing device(s) (e.g., digital lockbox 150) may each be implemented as the computing device with architecture 1400 described below and illustrated in FIG. 14.

Digital lockbox 150 can store and act as a gatekeeper for sensitive data. Data service 162 can include a secure database or access to a secure database to store such information. Additionally, data service 162 can both include additional functionality as well as interactions with other services of digital lockbox 150. In some examples, data service 162 includes an application programming interface (API) to facilitate network access to the data manage by data service. The API can allow access to specific data of data service 162, for example, by use of unique one-time URLs. In some examples, data service can identify and track party affiliations with certain data. For example, data access sessions (e.g., groups of communications associated with a transaction, a unique token, or other such communication groupings) can be associated with a physical location (e.g., a merchant store), an specific originating device 110 (e.g., individually tracking 20 different originating devices 110 in a location), by an account identifier (e.g., associated with a merchant employee logged into an originating device), by a user, or by any other such association for a transaction. If a user A visits a store location M and is helped by employee X using originating device Z, some examples can track both the data stored in lockbox 150 for the transaction, the individual communications that are part of the transaction (e.g., communications receiving or transmitting the secure data stored in digital lockbox), as well as each action by user A, employee X, or device Z. Data analysis or grouping of data for multiple employees or originating devices can be used to track data at different levels, such as at a store location M level, a regional group of stores, departments within a store location (e.g., groupings of employees or devices within a store) or across multiple stores (e.g., performance of a particular department across multiple stores). Such data can be tracked and related to interactions with secure data and a digital lockbox, without providing any access to the secure data. In some examples, access to such data can further be tracked, such that a request for metrics associated with a digital lockbox are assigned a unique token and/or a single use URL, and tracked as described herein. Metrics can include offer acceptance rates at a POS level, location level, employee level, regional level, or at any other such level. Such a system can provide dynamic tracking of system use and secure data access in real-time, while maintaining data security. As transactions occur, the data in a digital lockbox can be updated in real-time with the details of a secure transaction communication (e.g., requests, unique token generation, passing of a token to different entities, and use of the token to access secure data from the digital lockbox). Metrics can similarly be updated in real-time as transactions occur, allowing real-time tracking of dynamic system use.

As described herein, a user device 124 can be used in conjunction with originating device 110 to establish secure communications between user 122 and retailer system 108. In some contexts, a user 122 is concerned about privacy and financial communications, in particular with respect to a retailer employee that may be communicating with user 122. A user 122 can additionally have concerns about data being communicated with retailer system 108 being visible to checkout employees of the retailer in ways that user 122 can wish to avoid, such as the possibility of a credit request being rejected. Examples described herein use a unique URL generated by URL generate 152 of authentication entity 106 to establish secure communications between user device 124 and retailer system 108 in ways that enable additional privacy and security. This also enables initiation of certain data communications using originating device 110 to allow a retailer to improve sales through offers to users made through devices associated with the retailer, such as originating device 110.

In various examples described herein, originating device 110 can use information from retail system 108 to identify offers available from system 104. In response to an indication of interest from a user 122 (e.g., using originating device 110), the retail computing system 108 can communicate request data to authentication entity 106. This can include identifying information from originating device 110 or user device 124 that can be used by device authentication service 154 to confirm information regarding devices related to the request data. This can include data about a location or store associated with originating device 110. This can include identifying account information, location information, or any other such context information about user device 124. The request data and information from device authentication service 154 can also provide information to other services. For example, SMS service 156 can identify whether authentication entity 106 has authorization to communicate with user device 124 in accordance with regulations limiting the ability for a business to initiate communications with user devices such as device 124. Additionally, based on other information associated with the request data, such as an expected credit request associated with the request data, pre-fill service 158 can be activated to identify or generate information for a credit request or other such information to be used in a subsequent communication from authentication entity 106 to either user device 124 or originating device 110.

Token service 160 can act in a number of ways to facilitate secure communications between user 122 and various other services and devices, including retail computing system 108 and issuing system 104. Additionally, token service 160 can tokenize a URL generated for user 122 by URL generator 152 in response to request data received via retail computing system 108. Tokenization is a process of substituting sensitive data elements with non-sensitive equivalents (e.g., tokens). The token is a reference identifier that can be mapped to the sensitive data via token service 160. Such a token service 160 can use large random numbers in combination with other systems, such as timing systems, to limit and secure the use of sensitive data being communicated over networks such as networks 120.

In some systems, information from an originating device 110 can be used by a token service 160 to generate a secure unique URL via URL generator 152 that has a use specific to retail computer system 108 or originating device 110. Such use can further be limited by use specific to user 122 or user device 124. Additional limits can be applied to specific items 128 in association with a specific user 122 or originating device 110. For example, if request data received at authentication entity 106 includes information about a location for originating device 110, an item 128 at that location that a user 122 is considering purchasing, along with information about the user device 124 and a credit request, then a token service 160 can create a secure URL in conjunction with URL generator 152 to facilitate a credit offer specific to the location of originating device 110 and purchase item 128 that can only be accessed by user device 124. Additional limitations such as time limitations can be added, so that the secure URL can only be accessed via user device 124 for a limited amount of time (e.g., 10 minutes, 1 hour, 1 day, etc.) Token service 160 can be used in conjunction with other information both to allow generation of a tokenized URL with URL generator 152, as well as to manage responses to the URL initiated from user device 124. This can include generating responses when a time limit is exceeded or an unexpected device uses the secure URL. This can also include accessing secure information with a token that is received from an authorized device (e.g., client device 124 or originating device 110).

As described above, in some examples, authentication entity and credit issuing system 104 can, in some implementations, be the same system. In such a system, a token service 160 can further act to generate tokens for credit numbers or other aspects of financial transactions which involve credit system 104. In additional examples, other aspects of system 100 can further be altered or include additional or intervening elements, such as multiple users, users with shared accounts, additional merchant or retailer systems, subsystems that can operate independently, such as the use of an independent SMS service 156, or any other such structure for a system 100.

For example, the originating device 110 associated with a merchant's computing system 108 can be used as part of a transaction for items 128 by user 122. As part of a transaction session in the network, a user interface on display 114 of the originating device 110 or an associated merchant computer (e.g., operated by a merchant employee) can enable an account or credit application for funds to be used as part of the current transaction, an account lookup operation, or another similar secure authentication action. If a user 122 elects to initiate such an application, the user 122 provides the originating device 110 (or a related merchant device) with an identifier (e.g., a phone number) associated with user device 124.

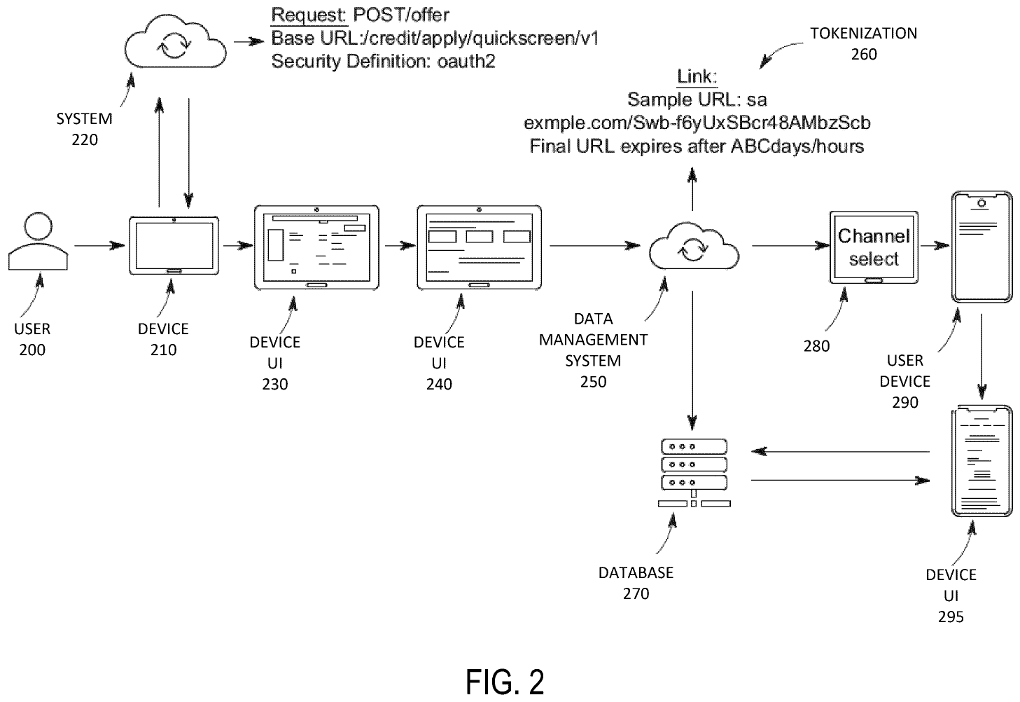

FIG. 2 then illustrates an example of network data management using a system 250 (e.g., including a digital lockbox 150). In the illustrated flow of FIG. 2, a user 200 (e.g., similar to user 122) interacts with an originating device 210 (e.g., similar to originating device 110) to initiate communication of request data. The initiation of the request data communication can occur either via a user inputting data directly to a device 210, via the user allowing a retail employee to provide this information, via a retail computing system that has information from a user automatically providing request data based on a user authorization, via a user device being authorized to provide information for request data to a retail computer system, or via any other such acceptable operations. In some examples, the request data is generated in response to offer data in a retail computer system 220. For example, when a user 200 interacts with an originating device 210, the originating device 210 can access available offers from a retail computer system 220, or suggest an account lookup option for a merchant-based payment account. Offer data can be general (e.g., not based on any data specific to a user) or can be user specific (e.g., based on context or other information about user 200).

In some examples of specific offers, the retail user system can access secure data or can initiate interactions with an authentication system to access initial information about offers specific to a user. In one such example, an originating device can pass simple user information to an authentication system via a retail system. The authentication system can return a prequalification response as an offer with an offer identifier. A pre-qualified interface can then be presented on the originating device. The pre-qualified offer can then be presented directly to a user via the originating device, or can be made verbally to the user via a retailer employee. If the offer is accepted, the request data can include the offer identifier as identifying information associated with a particular retailer (e.g., retail location, employee information, or other such related information). In other examples, any data source can be used for initial offer, including third party data sources. In some examples, a user will interact with a user interface (UI) 230 at an originating device to provide additional information, generate a retail account, indicate an interest in possible offers, or provide other such information. In a request interface 240, a user selects an offer to initiate request data to a data management system (e.g., authentication entity 106).

This request data is received at data management system 250 and processed to identify an appropriate action in response to the request data. In some systems, data management system 250 can accept a variety of different types of request data and can channel the request data to an appropriate service. In various data management systems 250, the services connected with data management system 250 can be modular, such that the services can be updated and altered seamlessly without changes to system inputs. This can allow a standard set of request data from an originating device 210 to be processed at data management system 250 as the services used by data management system 250 are updated over time. Regardless of the service associated with particular request data, as long as an associated service is identified for the request data, a secure uniform resource locator (URL) is generated in response to the request data. The secure URL (e.g., a one-time link tokenized for security) can be generated using a token service in conjunction with a URL generator service as described above in an operation of tokenization 260.

Depending on the request information, a channel selection 280 can occur to determine how the unique URL is to be communicated to a user. If the authentication service has the information to contact the user and is authorized to contact the user, the channel can be a direct channel from the authentication system to the user (e.g., via e-mail or SMS). If the authentication system is not authorized to communicate with the user, the link can be communicated to the user via the retail computing system or the originating device (e.g. via a network from the authentication system to the retailer, and then to the user device from the retail system via SMS).

When the user device receives the secure unique URL, the user device can then initiate secure communications using the token service. This can include secure applications for credit or other such actions. In the example of FIG. 2, upon receiving the request information, the authentication system not only generates the secure unique link, but also accesses a database 270 for information about the user associated with the request. Data from the database 270 can be used to generate a prefilled credit application. Use of the secure URL by the user device 290 can result in the token service providing access to the prefilled credit application at interface 295. The user can then proceed with secure communications to finalize the credit request and use any authorized credit in a purchase associated with the offer used to initiate the request. If the credit request is denied, the denial can be communicated to the user device in a manner that is opaque to a retail employee to protect user privacy.

In other examples, rather than the database 270 providing the prefilled application in response to a user device 290 using the secure unique link, the prefilled application data can be structured within a two-dimensional barcode, and communicated either to the originating device or another such device to be accessed by the user device. In such a system, the secure one-time link can be used with the two-dimensional barcode to facilitate additional communications related to the credit request or other communications between the retail computer system and the user device.

In one example, the user 200 is at a location having a point of sale (POS) device 210 connected to a computing system 220 associated with a merchant and the POS device 210. When the user 200 initiates a purchase transaction at device 210, the device 210 accesses offer or account information available from system 220. System 220 returns data that is presented via device UIs 230 and 240. When a user selects an offer via device 210, request data associated with the user selection (e.g., including a user's cell phone number for user device 290) is transmitted to system 250 (e.g., which implements or includes a digital lockbox 150 or aspects of a similar digital lockbox system). The system 250 accepts the request data using an API, and can confirm that relevant information is stored or managed by system 250. If additional data can be accessed in response to the request data that is not currently stored in system 250, system 250 can request the data, and add the data to storage or data service systems of system 250. System 250 can then use a token service in response to the request data to create a single use tokenized URL for data stored in the system 250. The API allows such single use URLs to be received at system 250 and to identify data stored in system 250 are accessible by system 250. For example, personal data for a requesting user can be kept at a location A in system 250. A tokenized single use URL can use a unique token with information about the personal data or the location A to generate a URL: sa example.com/Swb-f6yUxSBcr48AMbzScb. This URL can be associated with the network location in system 250 used to access sensitive data associated with the request data. The tokenized URL can then be communicated to user device 290 using the phone number provided with the request data. When the user device 290 receives the single use URL, the URL can be used to access relevant data in database 270 using the API of system 250 with the URL (e.g., where the API can use the unique one-time URL to identify the appropriate network location for the sensitive data). The sensitive data can then be used to facilitate additional communications between system 220 and user device 290, such as purchase transactions, account lookup operations, credit applications, etc.

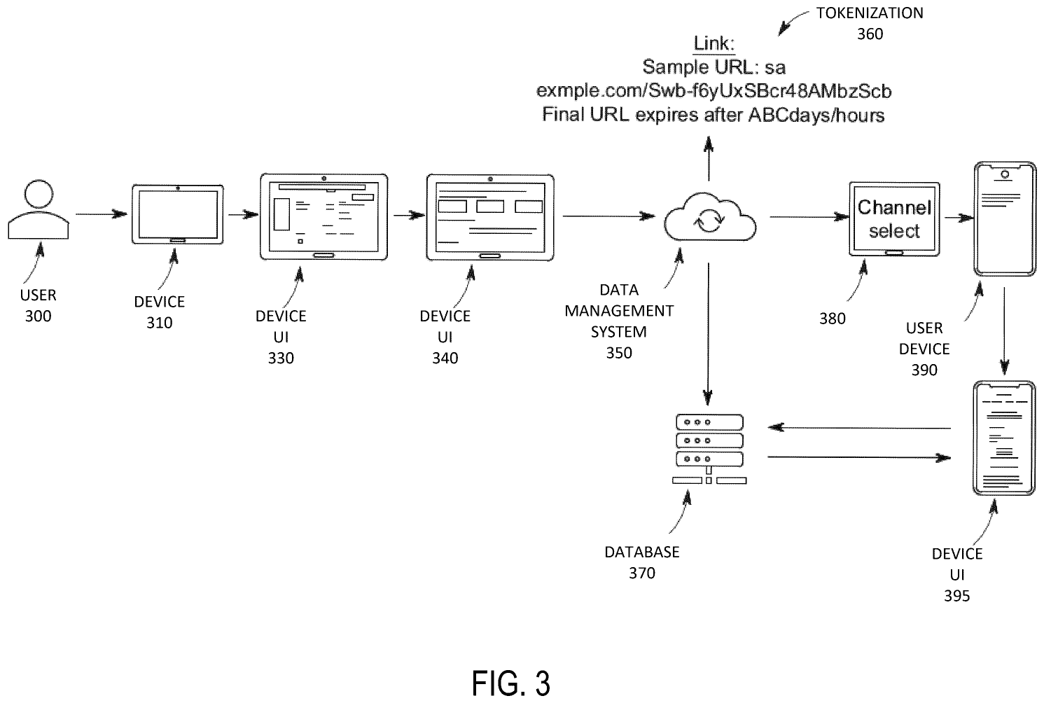

While the examples of FIG. 2 show the use of communications associated with an offer (e.g., via retail system 220), in the example of FIG. 3, the offer occurs directly via the originating device and is sent to the system 350 without prequalification or other initial communications. In such a system, a user 300 interacts with an originating device 310. Just as above, this can occur either directly or using a retail employee. Using interfaces 330 and 340, an offer is presented via the originating device, and the originating device is used to generate and send request data to system 350 (e.g., using an API to access secure data in a digital lockbox of system 350). This request data can include an application identifier, a username and address or other such information. In some examples, this can include contact information for a user such as email or phone number information, or additional identifying information such as a date of birth. This information can then be used by system 350 as described above for generation of a secure one-time link 360, access to database 370 information, channel selection 380, and additional service operation such as presentation of the secure one-time link and associated credit offers via interfaces 390 and 395.

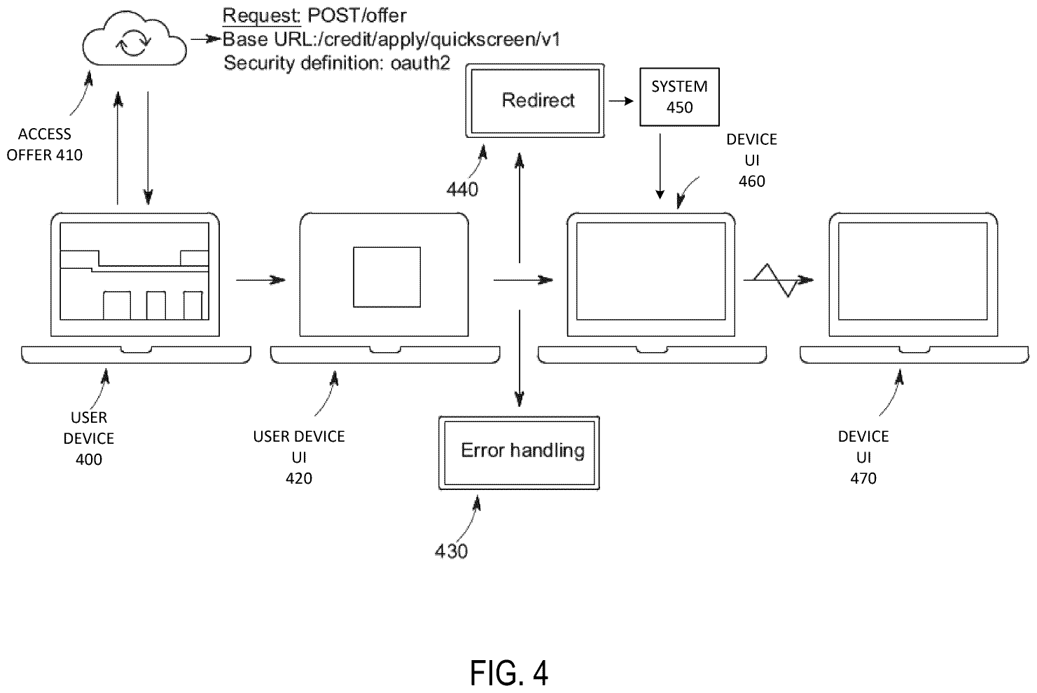

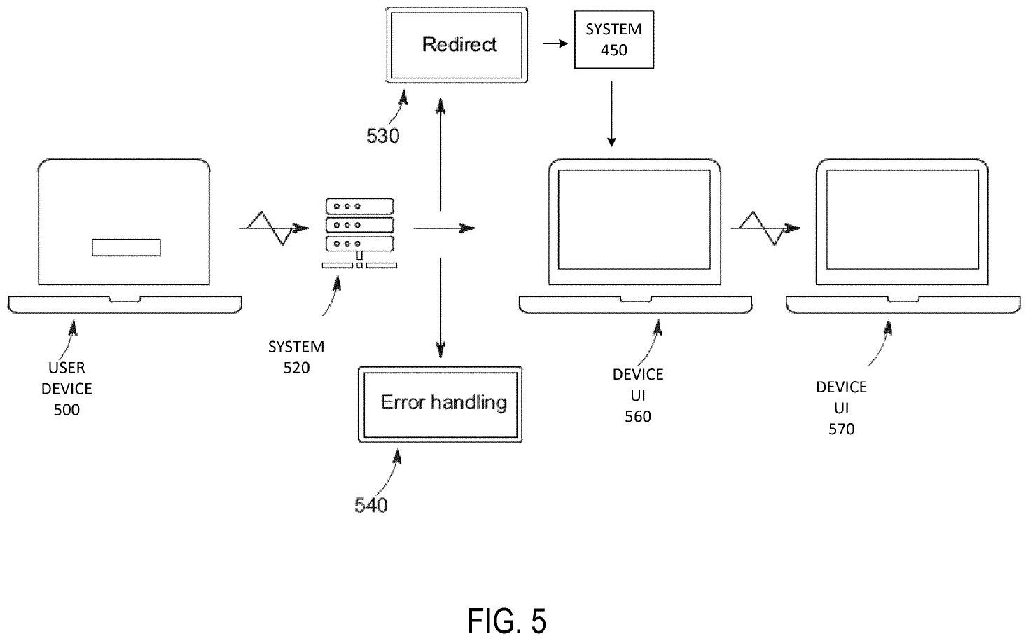

FIGS. 4 and 5 then illustrate additional examples of network data management similar to those of FIGS. 2 and 3, but in a context of a client's device operating as both the originating device and the user device (e.g. for internet communications). In FIG. 4, a user device 400 logs into a retail computer system (e.g., via a retail website). The account information associated with the login can be used to access offers 410, either from the retail computer system or from a third party. As described above, this can include accessing authentication systems for an initial prequalification of a credit offer. The offer can be presented to a user via a user interface 420. If the offer is accepted, a redirect to the authentication system occurs to generate a secure one-time link in redirect 440. This redirect 440 operation can include communication of an offer identifier, a user identifier, and any other such information. The redirect 440 can then use the API of system 450 (e.g., including a digital lockbox and tokenization service) to generate a unique token for the request data provided by redirect 440. The secure one-time link can then be communicated back to the user device. When the user device uses the secure one-time link any error handling 430 is first considered. This can include expiration of the secure one-time link, errors or corruption associated with the link, or any other such problems. For example, if the secure one-time link is shared with a device that is not authorized to use the link, an error handling 430 operation can be triggered. If no error handling 430 event occurs, then the secure communications between user device 400 and the retail computer system can proceed with secure network data management handled using the secure channel initiated with the secure one-time link. This can include further operations and a user interface 460 for a full credit application with terms, as well as an approval and other disclosure information in an interface 470. In some examples, the secure channel initiated with the secure one-time link can be an encrypted communication using RSA, AES-256 in ECB or CTR, secure communications via SDP, or any other such communication.

Similarly, as the operations of FIG. 4 are similar to the operations of FIG. 2, but without direct inclusion of a retail location, the operations of FIG. 5 are similar to the operations of FIG. 3, but via e-commerce instead of via a device which is at a retail location. In FIG. 5, a user device 500 interacts with a retail computer system 520, and receives a local offer from the retail system 520. The user accepts the offer at the user device 500, and the request data is generated and sent to the authentication system 450 (e.g., including a digital lockbox and token service) via the redirect 530 using an API for system 450. A secure one-time URL is generated, and if no error handling 540 exception is triggered, the authentication system facilitates secure communications for additional services via user interfaces 560 and 570 at the user device. As described above, this can include credit applications and responses, credit and payment transactions, or any other such secure communications.

In both FIGS. 3 and 4, once a redirect to the system including the digital lockbox occurs, a unique token is generated that can be used (e.g., as part of a single use URL) via an API of associated with the digital lockbox to access secure data in the system hosting the digital lockbox. In FIGS. 2 and 3, the unique token is passed to a user device using a phone number, in FIGS. 3 and 4, other mechanisms can be used to securely provide the token to the user device 400, which acts as both the originating device and the user device confirming the access to the secure data in the digital lockbox of system 450. In some examples, multiple single user URLs can be used for a single session, as secure data is accessed by a user device 400, and a system (e.g., a merchant system associated with access offer 410) as the system 450 passes access to different systems to facilitate secure and private data communications between the systems. communications

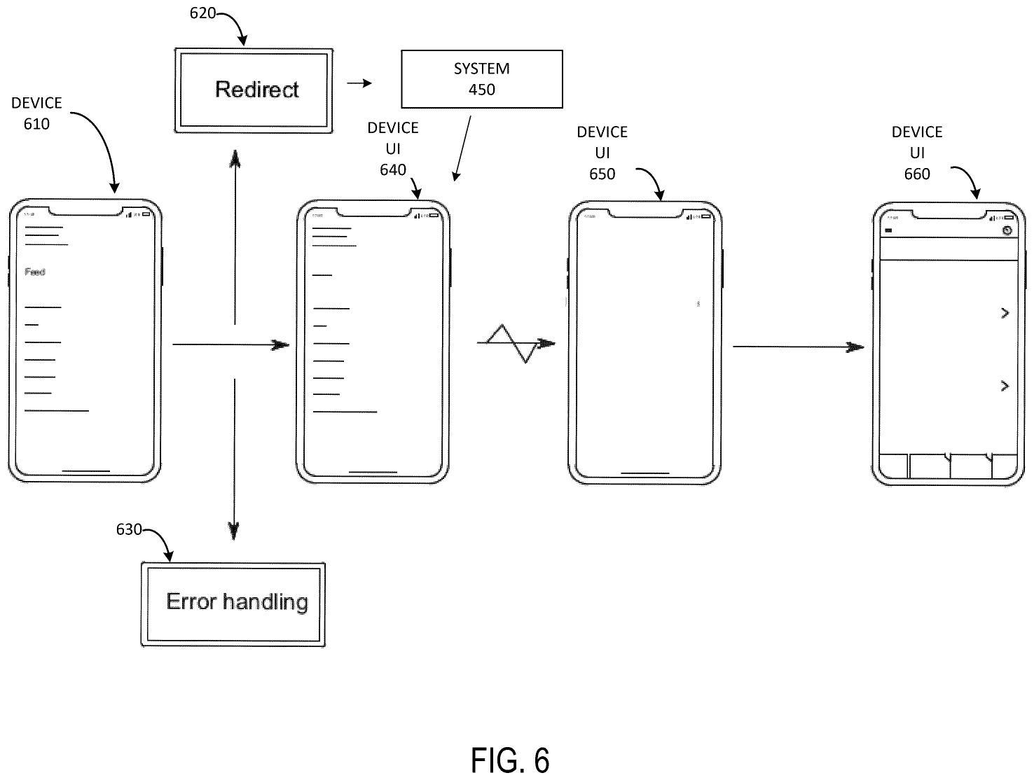

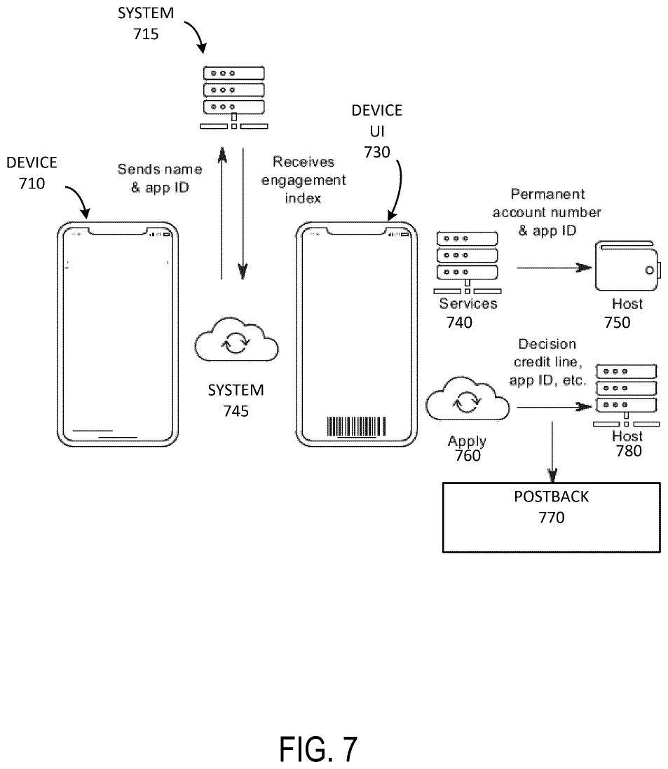

FIGS. 6 and 7 then illustrate similar operations to those described above for a mobile device 610 which can use multiple networks for communication. In FIG. 6, a user uses the user's mobile device 610 to initiate communication for request data (e.g., as part of a transaction or other secure communication) via the application or network server (e.g., website) of a host system (e.g., merchant or retailer). The host system manages error handling 630 and redirects 620 before system 450 (e.g., including a digital lockbox and token service) is used to access secure data. The request data is redirected to the authentication system 450, which generates a secure one-time URL. If no error handling occurs, a secure channel is established, and the user uses the secure channel to complete an application using sensitive information that is protected by the secure channel. Just as above, system 450 can use an API to accept request data via redirect 620, generate a single use tokenized URL identifying a network location (e.g., in system 450 accessible via the API of system 450) used to access secure data in the digital lockbox. User interfaces 640, 650, and 660 can be used to select a single use URL from system 450 to access data from the digital lockbox of system 450, and to perform additional access and communication operations, such as relaying secure information (or authorization to access the information) to a third system (e.g., a merchant system), or accessing additional secure or private data using the digital lockbox of system 450.

FIG. 7 illustrates similar operations, but with additional services available and initial interfaces for offers and options prior to the secure channel being established. The additional services can include initial prequalification from the authentication system or offers from third parties, presentation of various options, offers, and conditions prior to the secure channel being established, and the option to use the request data for multiple services, such as secure account data management, credit applications, and other such actions. In the example of FIG. 7, the initial request data from user device 710 is used by an authentication system 745 (e.g., including a digital lockbox and token service accessible by an API of system 745) to generate a secure one-time link, and that secure one-time link (e.g. a tokenized URL) is then used to establish a secure channel between a user device a service operated by system 715 (e.g. application for credit and use of credit at a retailer). The digital lockbox of system 745 can act as an intermediary between device 710 and system 715 to pass control tokens (e.g., associated with single use URLs identifying the location of secure data in system 745 accessible via the system 745 API) as part of a session or set of communications. Such operations can include facilitating services 740 with account number lookup operations at a host 750, or can include secure apply operations (e.g., access or credit account requests) with host 780, which can include postback 770 communications.

During any such service or operation facilitated by a digital lockbox of system 745 or any system above, a secure API can be used to access system 745. As described above, a data service of a digital lockbox can not only dynamically provide access to secure data, but can also create history data that tracks system use at various levels (e.g., user levels, device levels, business levels, location levels, service levels, etc.) In some examples, the history data can be updated in real-time as a user device and other devices access data in the digital lockbox of a system. For example, a user device 710 can be a cell phone with payment features. A user can use device 710 to access a merchant application or website to initiate a transaction (e.g., a purchase transaction for items 128). The merchant application or website can offer a user via a UI presented on device 710 both account lookup (e.g., associated with services 740) and credit application (e.g., associated with apply 760 operations) options. If a user selects an account lookup option, a redirect or request communication can be sent to system 745 to access associated secure data stored in a digital lockbox of system 745. System 745 can access secure data from system 715 or other such systems, and then generate a unique token for the data. A data service can track the request and the data gathering options, and associate the operations (e.g., both receiving the request and accessing data) with the user, the user device, and a merchant system associated with the application or website that initiated the generation of the token. As a unique single use URL is transmitted, used, and other actions are taken (e.g., dynamic access to secure data as part of account lookup via host 750, credit application via host 780, etc.), each operation can be tracked in real-time by a data service of system 745 as part of digital lockbox systems. Such tracked data can then be accessed to identify how secure data has been used by different users, user devices, merchant systems, initiating devices, etc. For example, a single merchant can offer access to secure data by any mechanism described above, including employee assisted access via POS devices in a store location, website access, mobile device application access, or any other such access. In some examples, data services for a digital lockbox can identify a set of secure data for a user, and store data on each type of access listed above, along with dates, times, data modifications, uses, results (e.g., errors, credit decisions, etc.). The data can then be aggregated across different users, merchant locations, or any other such tracked data to provide system use metrics which can be updated in real-time as data is gathered by system 745.

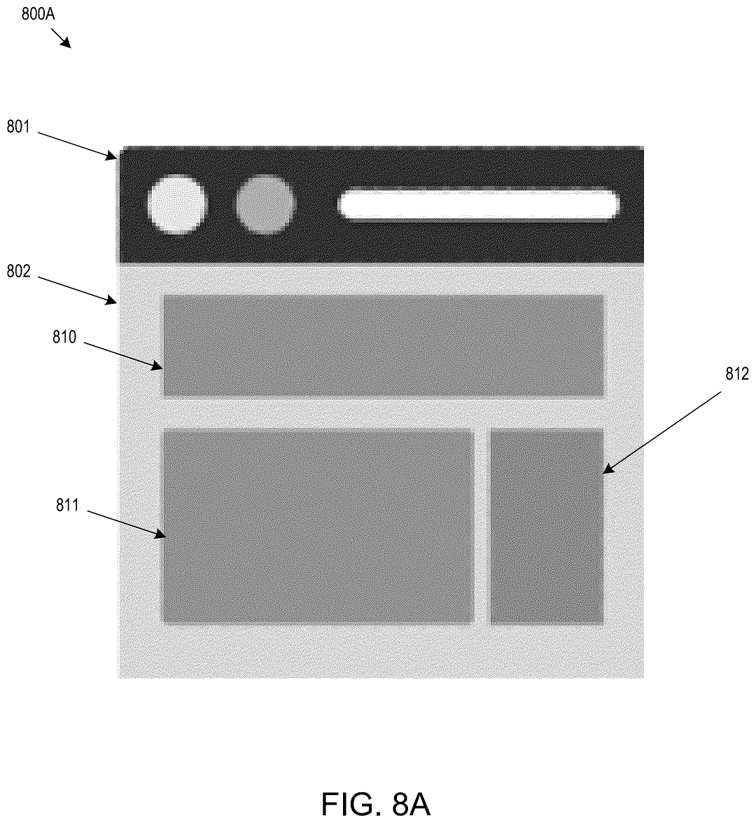

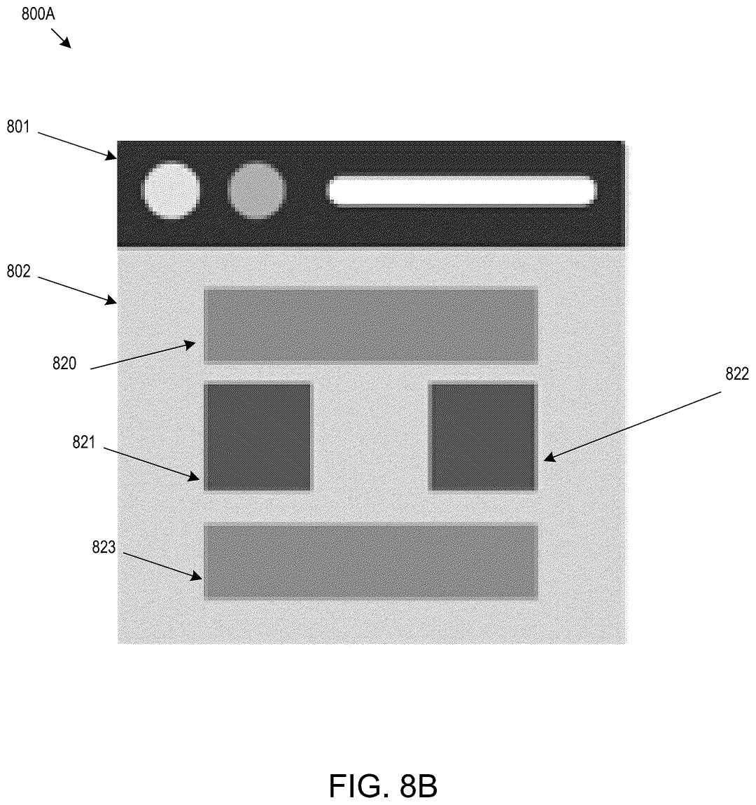

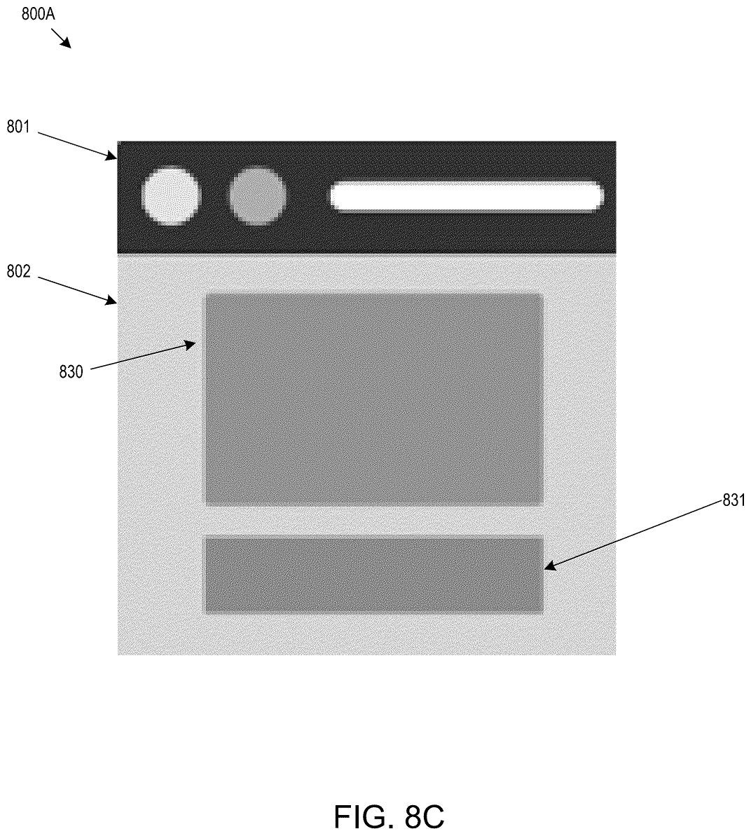

FIGS. 8A-C illustrate aspects of modular user interface configurations 800A-C for use in secure data flows for network data management in accordance with embodiments described herein. In FIGS. 1-7 above, devices having user interface hardware (e.g., the user device 124 having the display 126, the originating device 110 having the display 114, etc.) are present to facilitate secure and private communications. Additionally, in some figures, a single device can be associated with multiple device user interfaces (e.g., the device 210 and device UIs 230, 240, etc.). In such systems the structure and flow of the user interfaces can have a significant impact on the time taken to achieve desired device functionality. Aspects described herein can include modular versions of user interfaces with interface elements that can be reconfigured to improve device and system performance. Performance improvements can be tested and proved using multivariant experience testing as described below.

In some aspects, multivariant experience testing can use different user interface configurations (e.g., models) for a user interface experience or feature to allow quantitative and/or qualitative analysis of the impact of the different configurations on device performance (e.g., average device time or resource usage to achieve a target performance goal). In some aspects, human participants can use and evaluate the different models and feedback data can be used to generate data describing interface performance (e.g., engagement, completion time, etc.) In other aspects, automated testing or virtual users (e.g., modeled interactions using large language model artificial intelligence, automated interface interaction analysis, etc.) can be used to generate feedback data. In other aspects, combinations of such feedback data can be generated. Data can be generated for metrics such as ease of use, confidence, length, information density, security, trust, etc.

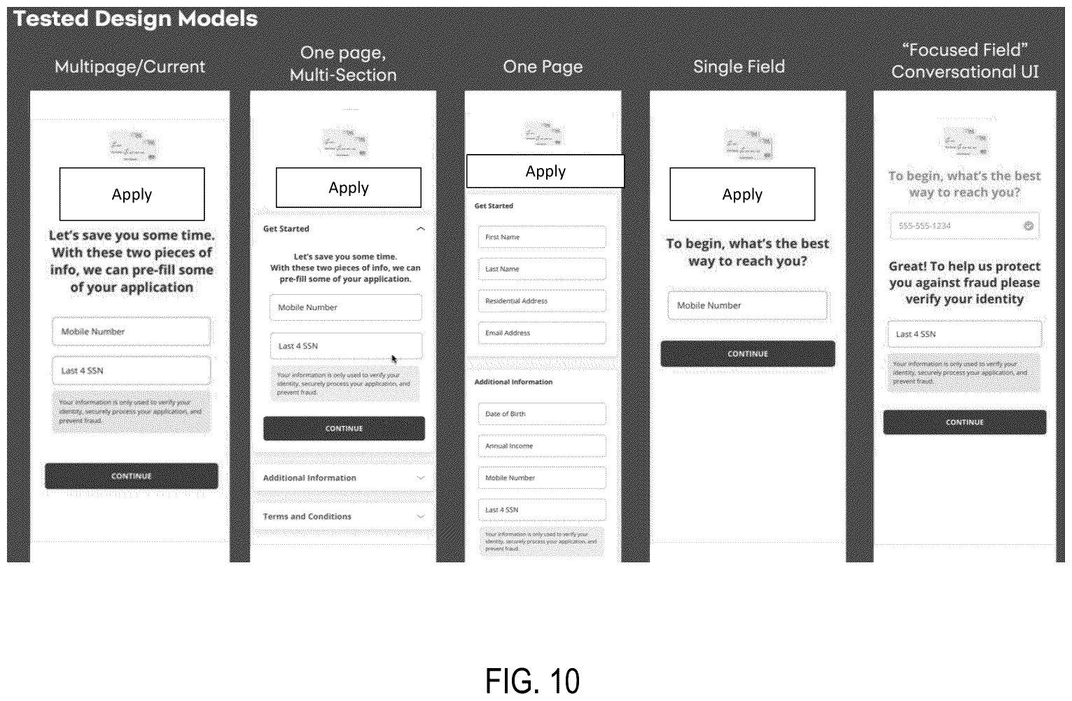

FIGS. 8A-C illustrate three different user interface configurations, shown as configuration 800A in FIG. 8A, configuration 800B in FIG. 8B, and configuration 800C in FIG. 8C. Each of the three configurations includes shared template elements 801 and a configurable interface area 802, along with different combinations of interface elements. The configuration 800A includes interface elements 810, 811, and 812. The configuration 800B includes interface elements 820, 821, 822, and 823. The configuration 800C includes interface elements 830 and 831. In some aspects, identical interface elements can be used in different configurations. For example, in some aspects, the interface elements 810, 823, and 831, which are illustrated as having a similar or same size and shape, can be identical elements positioned in a different combination with other interface elements for different configurations. Other elements can implement similar functionality with a different size or shape. Additional details related to changes in interface elements with shared functionality are described below, particularly with respect to FIG. 10.

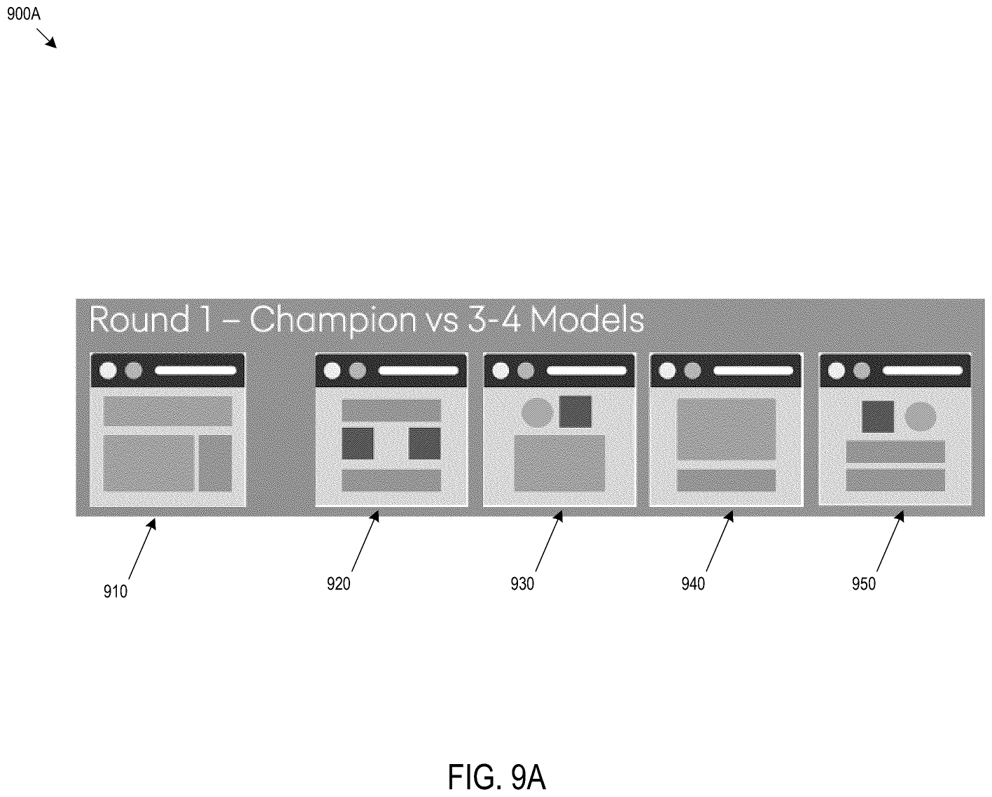

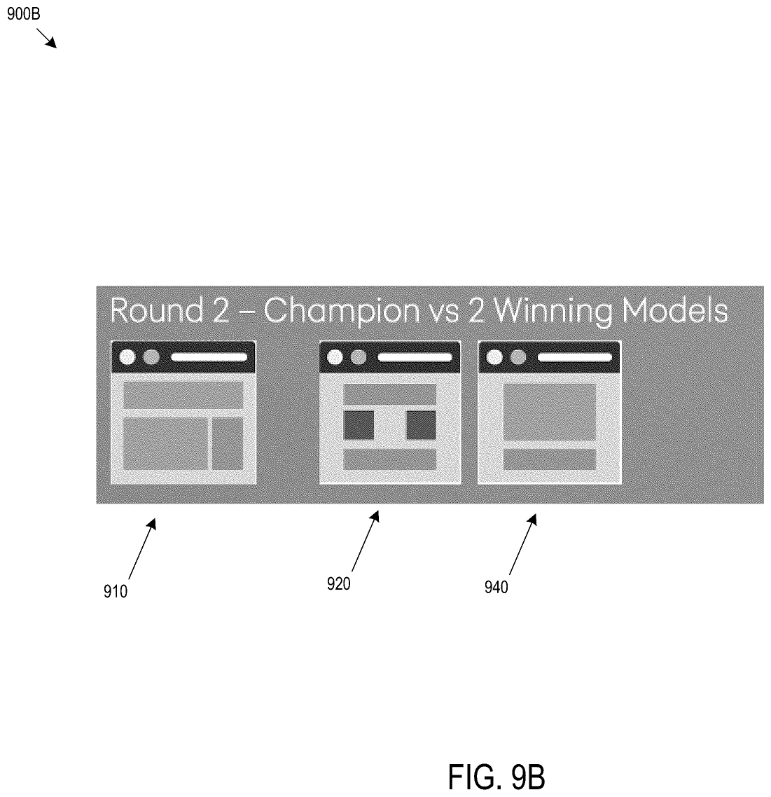

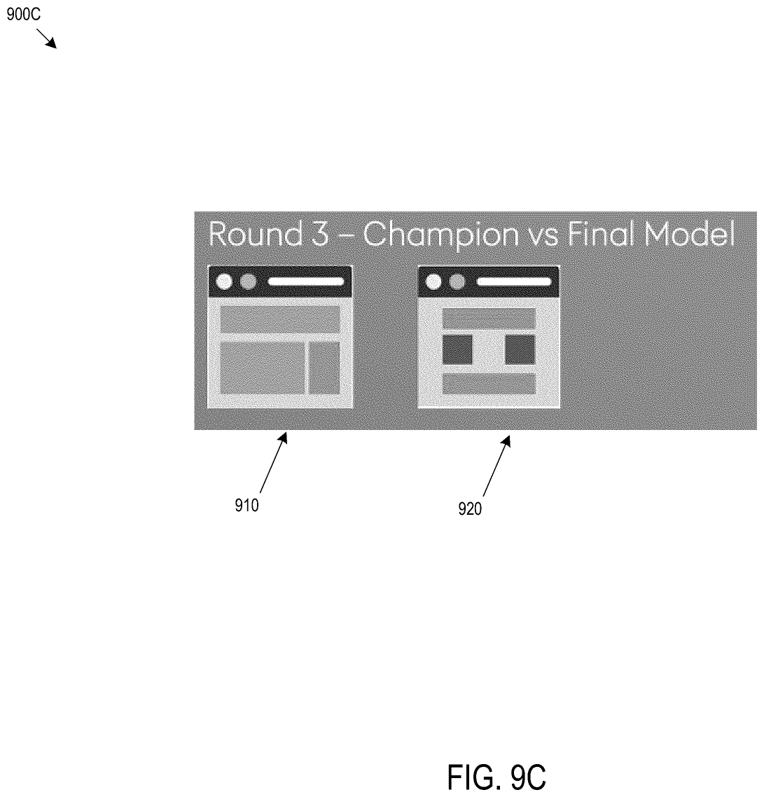

FIGS. 9A-C illustrate aspects of modular user interface testing in accordance with embodiments described herein. As discussed above, different interface configurations can be implemented and tested using a multivariant experience testing implementation in accordance with aspects described herein. In implementations of multivariant experience testing, rounds of model testing and comparison can be used. A “round” of testing may be referred to as an iteration, a set, a cycle, any combination thereof, or the like. In some aspects, multiple rounds of testing are used to manage any impact of the presence of multiple configurations on the feedback data.

FIG. 9A illustrates an initial round of data generation, where an implemented configuration is tested along with three or more alternate configurations with different interface elements. As shown, five configurations are present for the initial round of feedback data generation, shown as configurations 910, 920, 930, 940, and 950. As indicated above, testing can generate feedback or analysis data along a number of performance vectors. The testing may be performed by an automated process or may be performed by human experience testing. As such, performance may be measured according to subjective criteria and/or an objective criteria. For example, the performance vectors can be measurable metrics (e.g., criteria, dimensions, etc.) used to evaluate the configurations (e.g., configurations 910, 920, 930, 940, and 950) and evaluate how well the configurations perform under certain conditions. In the context of secure data flows, the performance vectors may assess usability and/or security effectiveness. For example, performance vectors may include, but are not limited to, resistance to phishing (e.g., how well the interface helps users identify and avoid fake or malicious prompts), exploit resistance (e.g., the interface's resilience to interface-based attacks like auto-fill abuse or misleading element placement), support for strong authentication (e.g., assesses the interface's support for secure login methods like strong passwords and multi-factor authentication), clarity of access controls (e.g., how clearly the interface communicates and manages user permissions or roles), handling of user errors (e.g., whether the UI allows users to recover from accidental or incorrect actions), tamper evidence (e.g., if the UI provides visible feedback when sensitive settings or sessions are altered), task completion time (e.g., how quickly users can complete a task using the interface), error rates (e.g., the frequency of mistakes users make while interacting with security-related elements), learnability (e.g., how easily a new user can understand and use the interface for secure tasks), memorability (e.g., how well users remember how to perform secure actions after a period of non-use), cognitive load (e.g., the mental effort required for users to complete a secure task, often via subjective scales), interface behavior under stress (e.g., how users perform security-related actions under pressure or distraction), consistency across devices (e.g., if secure behavior and design remain reliable on different platforms or screen sizes), visibility of security status (e.g., whether users can easily see and understand the current security state of the system), ease of use (e.g., how intuitively and efficiently users can navigate the interface to perform secure tasks without assistance), confidence (e.g., how certain users feel that they are performing secure tasks correctly and safely), length (e.g., total number of interactions and/or steps required to complete a process), information density (e.g., how much content is displayed in a given area and its impact on user comprehension and decision-making), trust (e.g., the user's belief that the system is secure, transparent, etc.), any combination thereof, or the like.

Such data can be generated either by human experience testing (e.g., one or more testing users provide feedback regarding one or more configurations), by automated analysis (e.g., performed by a statistical analysis, machine-learning analysis, any combination thereof, or the like), or a combination of both. For example, the data generated by evaluating the performance vectors may be objective (e.g., numerical, based on calculations, fact-based, etc.) or may be subjective (e.g., indicative of preference, personal skill, freeform user feedback using metrics as criteria, etc.). In some examples, a portion or all of the data may be associated with a respective configuration specifically. In some other examples, however, a portion or all of the data may be associated with specific interface elements of a configuration. For example, Configuration A may include Element A, Element B, and Element C. Configuration A may be associated with data, Element A may be associated with data, Element B may be associated with data, and/or Element C may be associated with data. In some other examples, groupings of interface elements may also be associated with a portion or all of the data (e.g., a combination of Element A and Element B may be associated with data).

The data from the initial round for all configurations is processed and used to limit the number of configurations that proceed to a next round. In some aspects, a new configuration can be generated for a next round based on the feedback data from a first round. For example, if one configuration achieve an overall highest set of feedback scores, but an element not present in that interface receives high feedback from a different configuration that receives overall lower scores, a new version of the highest feedback configuration using the positively reviewed element can be generated. In some aspects, automated testing rounds can be used to generate the set of configurations which are then narrowed down to a limited number of configurations presented to human users for feedback. Three rounds of feedback are shown in FIGS. 9A-C, but in other aspects, other numbers of feedback rounds can be used, with different rounds having different scoring and advancement criteria, and different feedback generation models (e.g., different performance vectors, human feedback, automated feedback or analysis, etc.) for a given implementation of multivariant interface testing in accordance with aspects described herein.

In FIG. 9B, two of the four alternate configurations are eliminated and the implemented configuration 910 undergoes additional feedback analysis with selected alternate configurations 920, 940. In some aspects, the implemented or live variation is kept for all rounds of feedback analysis. In other aspects, the live variation can be eliminated based on data from initial rounds of feedback data. Additional feedback analysis is then performed on the selected configurations 910, 920, and 940, and further elimination is performed.

In FIG. 9C, configuration 940 is eliminated, and a final round of feedback data generation is performed using configurations 910 and 920. Feedback data generation for individual configurations can be impacted by the simultaneous generation of feedback for another configuration, and so multiple rounds of feedback generation with narrowing groupings of configurations serves to limit the impact of such secondary influences on feedback data for an individual configuration. For example, in a first round illustrated in FIG. 9A, a user or system analyzing configurations 910 and 930 in a group may result in the analysis of configuration 930 having a negative impact on the analysis of configuration 910. Such an influence would be negated in the subsequent rounds when configuration 930 is not present. While such impacts are not a given, the use of multiple feedback rounds in multivariant testing in accordance with aspects described herein serves to manage such impacts.

In the final testing round of FIG. 9C, the final two configurations 910, 920 are tested in isolation of other configurations, and a highest performing configuration is selected, either confirming the configuration 910 (e.g., a live, selected, or “champion” configuration), or resulting in the configuration 910 being replaced with the alternate configuration 920 based on the feedback data. Configuration 910, as an illustrative example, may be implemented for use in a secure data flow for network data management.

FIG. 10 illustrates examples of modular user interfaces for use in secure data flows for network data management in accordance with embodiments described herein. FIG. 10 shows examples of 5 different configurations. Some of the illustrated configurations can have elements on multiple pages, so that the multipage configuration can include elements on multiple screens or UI displays that are included in a single display of a different configuration. In the example of FIG. 10, interface elements for collecting personal identifying information (PII) are presented, along with standard template information. The different configurations can use different configurations or emphasis to gather the same information, including different numbers of pages for multipage configurations, conversational data requests, different interface size configurations, and other such variations to achieve the same result (e.g., PII collection). In other aspects, other functions (e.g., other data collection, disclosure presentation, etc.) can be implemented with multiple configurations in accordance with aspects described herein.

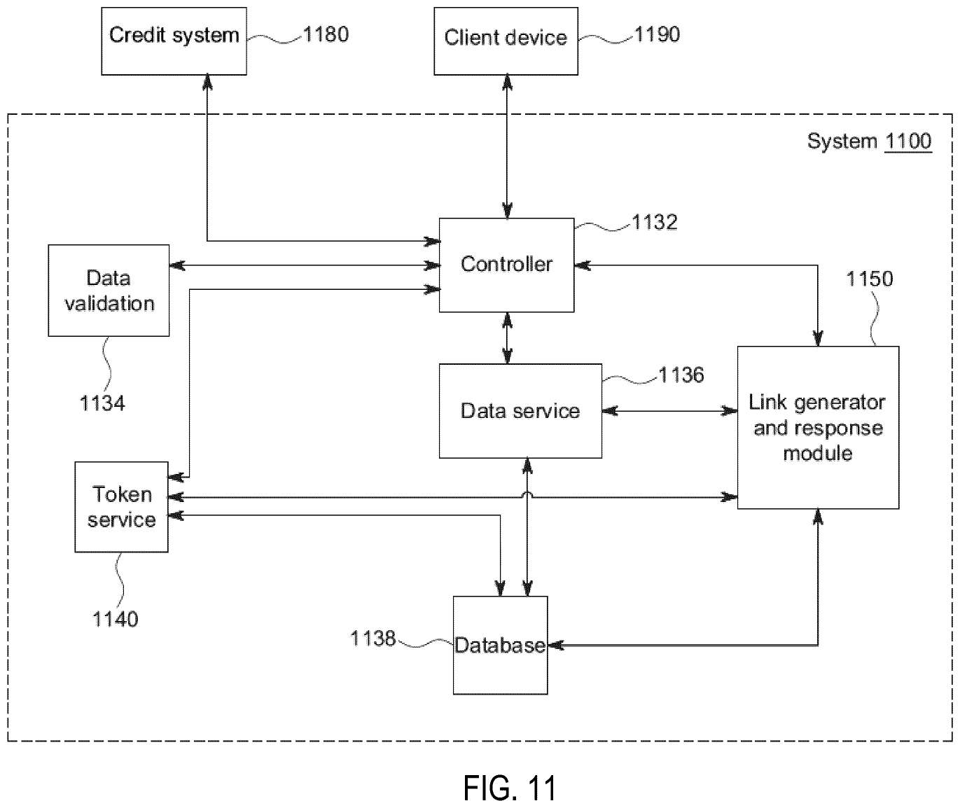

FIG. 11 then illustrates an example of an authentication system 1100 in communication with a user device 1190 and a credit system 1180 in accordance with one possible implementation. In the illustrated system of FIG. 11, a user device 1190 can provide request data to the authentication system. A controller 1132 processes the incoming request data and accesses a request validation service in data validation 1134. If the request is validated, the controller 1132 initiates generation of a token using module 1150. Additional details of module 1150 are described below. Module 1150 provides a secure one-time link to controller 1132. At any point, either in parallel to or after generation of the secure one-time link, the controller can also initiate a data fetch using data service 1136. This can include any information for a service to be called in response to the request data. In some implementations, data from the data service can be used with the initiation of the generation of the token and the one-time link. In other implementations, the data from data service 1136 (e.g., using database 1138) can then be available for various services enabled by the secure one-time link and associated secure channels. The controller 1132 then initiates communication of the secure one-time line to the authorized recipient (e.g., either directly to a user device or to the user via a host, retail, or computing system).

If the controller 1132 then receives an incoming communication using the secure one-time link, the controller 1132 accesses token service 1140 to verify the authenticity of the communication. This can include fetching data from module 1150 via data service 1136 and from the token service 1140. When the secure one-time link is verified, the token status is updated at token service 1140 to prevent the one-time link from being used again. The controller can then communicate with credit system 1180 to enable secure communications for decision making and facilitating a response to the request from the user.

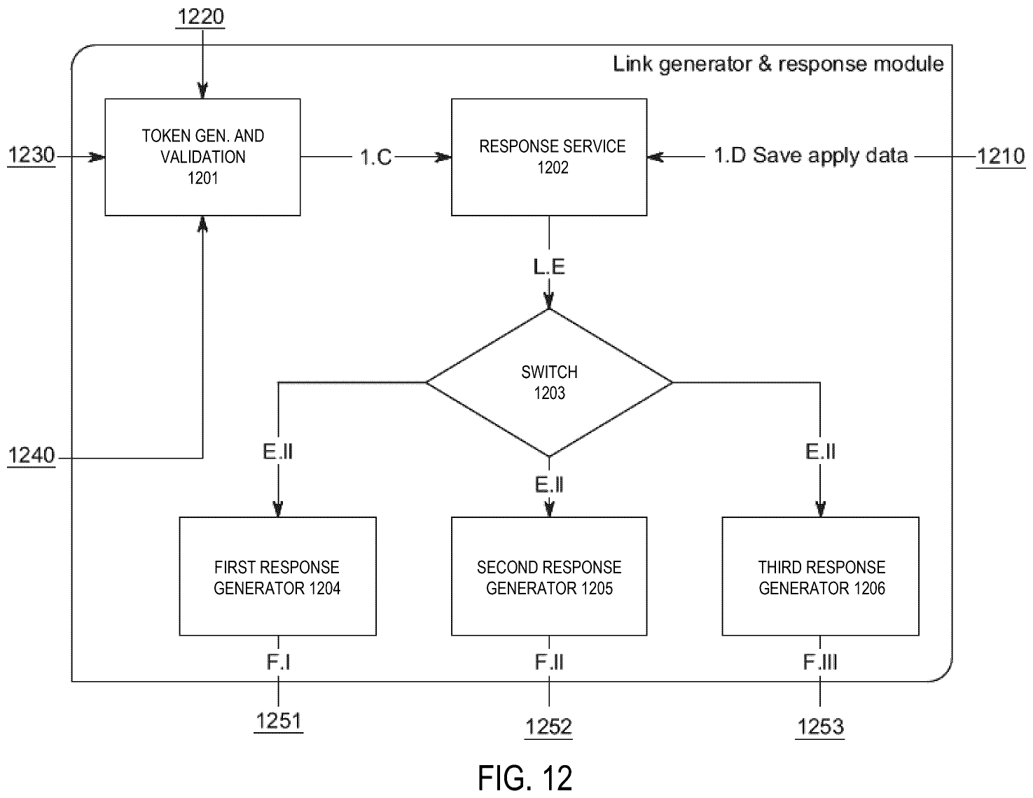

FIG. 12 describes an example implementation of a link generator and response module. While FIG. 12 shows one implementation, it will be apparent that other implementations are possible. The example of FIG. 12 includes a token generator and validator, a response service, and a communication channel selection system for selecting between different channel options for communication of a secure one-time link. The token generator and validator can have a connection 1220 to a controller such as controller 1132 to receive a communication initiating token and secure one-time link generation module 1201. The module 1201 (e.g., a token generator and validator) can also connect to data service 1136 and token service 1140 to allow verification of a received one-time link and an update to prevent the one-time link from being reused as part of a response service 1202. The response service 1202 can communicate with the token generator and validator of module 1201 to store appropriate information in a database such as database 1138 for future verification and to prevent one-time link reuse.

For systems that allow different channels for communication of a one-time link to a user, the link generator and response module includes switch 1203 circuitry for switching delivery methods. In the illustrated implementation of FIG. 12, switch 1203 enables multiple delivery channels. The example of FIG. 12 illustrates an example with three delivery channels shown as first response generator 1204, second response generator 1205, and third response generator 1206. In some examples, possible delivery channels include a communication channel for sending a one-time link to a user via a computing system, a channel for sending a one-time link to a user directly via email, or a channel for sending a one-time link to a user via SMS. In other examples, other combinations of more or fewer channels or channel types can be included, with switching or circuitry to select one or more of the available delivery channels. Each delivery channel can include different circuitry for generating appropriate secure communications in the selected channel with the secure one-time link. When the appropriate communication is generated, the controller can receive the information via the corresponding output 1251, 1252, or 1253 of the link generator and response module. The controller then routes the secure one-time link to the user via the selected delivery channel. In some implementations, the request data identifies the channel, and the channel is selected by parsing the request data. In other implementations, the link generator and response module selects from multiple available options based on data from a data service.

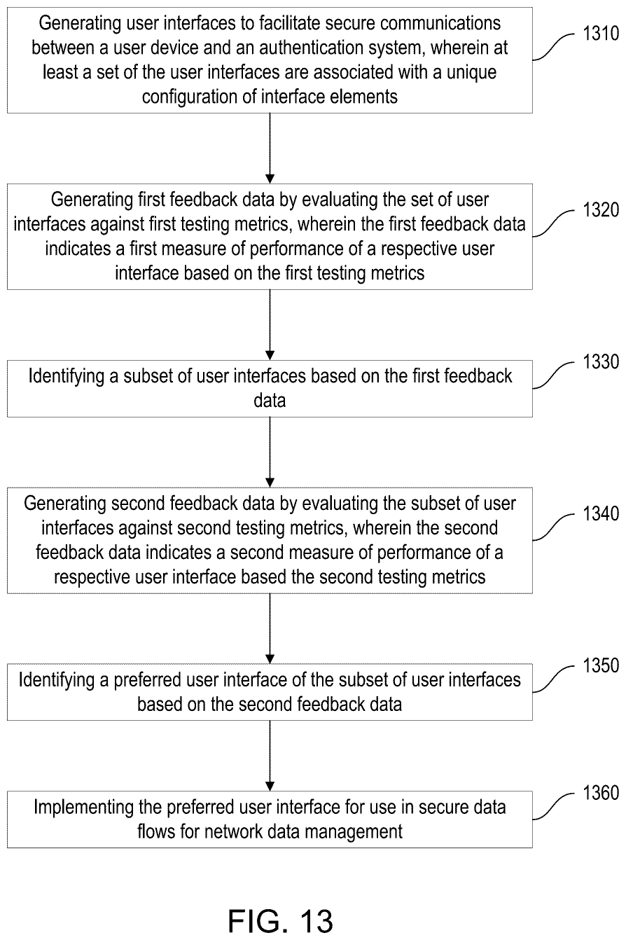

FIG. 13 illustrates an example flow chart for testing different organizations or structures of modular user interfaces according to some aspects of the present disclosure. In some examples, the steps described herein are to be construed as exemplary and are not intended to limit the scope of the disclosure. For example, the steps described herein may be performed in a sequence that differs from what is described in FIG. 13 or be performed concurrently.

At step 1310, an interface testing system generates user interfaces to facilitate secure communications between a user device and an authentication system, wherein at least a set of the user interfaces are associated with a unique configuration of interface elements. The unique configurations may include the same elements, but placed in a different location and/or in a different combination within individual user interfaces (e.g., Interface A includes Element A and Element B, while Interface B includes Element A and Element B). In some other examples, the unique configurations may share a portion of interface elements, while include individual elements that are unique to a respective user interface (e.g., Interface A includes Element A and Element B, while Interface B includes Element B and Element C). In other examples, all elements of the user interfaces may be unique (e.g., Interface A includes Element A and Element B, while Interface B includes Element C and Element D). The user interfaces may be configured to receive secure data from a user device and transmit the secure data to a service and/or system (e.g., system 450, system 745, etc.).

At step 1320, the interface testing system generates first feedback data by evaluating the set of user interfaces against first testing metrics, wherein the first feedback data indicates a first measure of performance of a respective user interface based on the first testing metrics. The testing system may generate the first feedback data by executing one or more automated processes and/or by implementing human experience testing during an initial iteration of testing. As such, performance may be measured according to subjective criteria and/or objective criteria. For example, the performance vectors can be measurable metrics (e.g., criteria, dimensions, etc.) used to evaluate the unique configurations and evaluate how well the unique configurations perform under certain conditions. Such data can be generated either by human experience testing (e.g., one or more testing users provide feedback regarding one or more configurations), by automated analysis (e.g., performed by a statistical analysis, machine-learning analysis, any combination thereof, or the like), or a combination of both. For example, the data generated by evaluating the performance vectors may be objective (e.g., numerical, based on calculations, fact-based, etc.) or may be subjective (e.g., indicative of preference, personal skill, freeform user feedback using metrics as criteria, etc.).

In the context of secure data flows, the performance vectors may assess usability and/or security effectiveness. For example, performance vectors may include, but are not limited to, resistance to phishing (e.g., how well the interface helps users identify and avoid fake or malicious prompts), exploit resistance (e.g., the interface's resilience to interface-based attacks like auto-fill abuse or misleading element placement), support for strong authentication (e.g., assesses the interface's support for secure login methods like strong passwords and multi-factor authentication), clarity of access controls (e.g., how clearly the interface communicates and manages user permissions or roles), handling of user errors (e.g., whether the UI allows users to recover from accidental or incorrect actions), tamper evidence (e.g., if the UI provides visible feedback when sensitive settings or sessions are altered), task completion time (e.g., how quickly users can complete a task using the interface), error rates (e.g., the frequency of mistakes users make while interacting with security-related elements), learnability (e.g., how easily a new user can understand and use the interface for secure tasks), memorability (e.g., how well users remember how to perform secure actions after a period of non-use), cognitive load (e.g., the mental effort required for users to complete a secure task, often via subjective scales), interface behavior under stress (e.g., how users perform security-related actions under pressure or distraction), consistency across devices (e.g., if secure behavior and design remain reliable on different platforms or screen sizes), visibility of security status (e.g., whether users can easily see and understand the current security state of the system), ease of use (e.g., how intuitively and efficiently users can navigate the interface to perform secure tasks without assistance), confidence (e.g., how certain users feel that they are performing secure tasks correctly and safely), length (e.g., total number of interactions and/or steps required to complete a process), information density (e.g., how much content is displayed in a given area and its impact on user comprehension and decision-making), trust (e.g., the user's belief that the system is secure, transparent, etc.), any combination thereof, or the like.

At step 1330, the interface testing system identifies a subset of user interfaces based on the first feedback data. In some examples, all or a portion of the first feedback data is associated with respective configurations. In some examples, all or a portion of the first feedback data is associated with interface elements of the set of user interfaces. The data from the initial iteration for all configurations is processed and used to limit the number of configurations that proceed to a subsequent iteration. In some aspects, a new configuration can be generated for the subsequent iteration based on the feedback data from the initial iteration. For example, the new configuration can include interface elements of the set of user interfaces, but configured in a different arrangement, order, size, spacing, color, any combination thereof, or the like. In some aspects, automated testing iterations can be used to generate the set of unique configurations which are then narrowed down to a limited number of configurations presented to human users for feedback. In some examples, the interface testing system generates a measure of performance for individual user interfaces (and/or interface elements) based on the first feedback data, then compares respective measures of performance (e.g., a score) for individual user interfaces of the set of user interfaces to identify the subset.

At step 1340, the interface testing system generates second feedback data by evaluating the subset of user interfaces against second testing metrics, wherein the second feedback data indicates a second measure of performance of a respective user interface based the second testing metrics. The testing system may generate the second feedback data by executing one or more automated processes and/or by implementing human experience testing during an initial iteration of testing. The second feedback data may be generated in a manner similar to the first feedback data (e.g., by evaluating performance vectors associated with configurations and/or interface elements). In some examples, the second testing metrics are different from the first testing metrics. However, in some examples, the second testing metrics are the same as the first testing metrics.

At step 1350, the interface testing system identifies a preferred user interface of the subset of user interfaces based on the second feedback data. The preferred user interface may be the “highest performing” configuration of the set of user interfaces (e.g., the highest first measure of performance and/or the highest second measure of performance). For example, the preferred user interface may be the user interface with a unique configuration that includes a highest score.

At step 1360, the interface testing system implements the preferred user interface for use in secure data flows for network data management. For example, the preferred user interface may be implemented at one or more UIs (e.g., device UI 730, display 126, device UI 330, device UI 340, device UI 395, user device UI 420, device UI 460, device UI 470, device UI 560, device UI 570, device UI 640, device UI 650, device UI 660, device UI 730, etc.). The interface testing system may transmit the preferred user interface with instructions to present the preferred user interface on a display device. For example, the interface testing system transmits the preferred user interface to devices having user interface hardware (e.g., the user device 124 having the display 126, the originating device 110 having the display 114, etc.) and the devices having user interface hardware may present the preferred user interface to a user to facilitate secure and private communications.

FIG. 14 illustrates a computing system architecture 1400 including various components in electrical communication with each other using a connection 1406, such as a bus, in accordance with some implementations. Example system architecture 1400 includes a processing unit (CPU or processor) 1404 and a system connection 1406 that couples various system components including the system memory 1420, such as ROM 1418 and RAM 1416, to the processor 1404. The system architecture 1400 can include a cache 1402 of high-speed memory connected directly with, in close proximity to, or integrated as part of the processor 1404. The system architecture 1400 can copy data from the memory 1420 and/or the storage device 1408 to the cache 1402 for quick access by the processor 1404. In this way, the cache can provide a performance boost that avoids processor 1404 delays while waiting for data. These and other modules can control or be configured to control the processor 1404 to perform various actions.

Other system memory 1420 may be available for use as well. The memory 1420 can include multiple different types of memory with different performance characteristics. The processor 1404 can include any general purpose processor and a hardware or software service, such as service 1 1410, service 2 1412, and service 3 1414 stored in storage device 1408, configured to control the processor 1404 as well as a special-purpose processor where software instructions are incorporated into the actual processor design. The processor 1404 may be a completely self-contained computing system, containing multiple cores or processors, a bus, memory controller, cache, etc. A multi-core processor may be symmetric or asymmetric.

To enable user interaction with the computing system architecture 1400, an input device 1422 can represent any number of input mechanisms, such as a microphone for speech, a touch-sensitive screen for gesture or graphical input, keyboard, mouse, motion input, speech and so forth. An output device 1424 can also be one or more of a number of output mechanisms known to those of skill in the art. In some instances, multimodal systems can enable a user to provide multiple types of input to communicate with the computing system architecture 1400. The communications interface 1426 can generally govern and manage the user input and system output. There is no restriction on operating on any particular hardware arrangement and therefore the basic features here may easily be substituted for improved hardware or firmware arrangements as they are developed.

Storage device 1408 is a non-volatile memory and can be a hard disk or other types of computer readable media which can store data that are accessible by a computer, such as magnetic cassettes, flash memory cards, solid state memory devices, digital versatile disks, cartridges, RAMs 1416, ROM 1418, and hybrids thereof.

The storage device 1408 can include services 1410, 1412, 1414 for controlling the processor 1404. Other hardware or software modules are contemplated. The storage device 1408 can be connected to the system connection 1406. In one aspect, a hardware module that performs a particular function can include the software component stored in a computer-readable medium in connection with the necessary hardware components, such as the processor 1404, connection 1406, output device 1424, and so forth, to carry out the function.

The disclosed gift selection, attribution, and distribution system can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein, for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

As used below, any reference to a series of examples is to be understood as a reference to each of those examples disjunctively (e.g., “Examples 1-4” is to be understood as “Examples 1, 2, 3, or 4”).

Example 1 includes a method, comprising: generating user interfaces to facilitate secure communications between a user device and an authentication system, wherein at least a set of the user interfaces are associated with a unique configuration of interface elements; generating first feedback data by evaluating the set of the user interfaces against first testing metrics, wherein the first feedback data indicates a first measure of performance of a respective user interface based on the first testing metrics; identifying a subset of the user interfaces based on the first feedback data; generating second feedback data by evaluating the subset of the user interfaces against second testing metrics, wherein the second feedback data indicates a second measure of performance of a respective user interface based on the second testing metrics; identifying a preferred user interface of the subset of the user interfaces based on the second feedback data; and implementing the preferred user interface for use in secure data flows for network data management.

Example 2 includes the method of example(s) 1, wherein the first testing metrics and the second testing metrics are the same.

Example 3 includes the method of example(s) 1-2, wherein the first testing metrics and the second testing metrics are performance vectors configured to evaluate how well the user interfaces perform under certain conditions.

Example 4 includes the method of example(s) 1-3, wherein generating the first feedback data and generating the second feedback data are performed using at least one of automated feedback and human feedback.

Example 5 includes the method of example(s) 1-4, wherein identifying the subset of the user interfaces based on the first feedback data further includes: generating a new user interface associated with a new configuration of interface elements that is distinct from the set of the user interfaces, wherein the new user interface is included in the subset of the user interfaces.

Example 6 includes the method of example(s) 1-5, wherein a first user interface includes a first interface element in a first position and a second user interface includes the first user interface element in a second position, wherein the first position and the second position are distinct.

Example 7 includes the method of example(s) 1-6, wherein prior to identifying the preferred user interface, the method further comprises: identifying a second subset of the user interfaces based on the second feedback data, wherein the subset of the user interfaces includes the second subset of the user interfaces; and generating third feedback data by evaluating the second subset of the user interfaces against third testing metrics, wherein the third feedback data indicates a third measure of performance of a respective user interface based on the third testing metrics.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the provided examples. A process may correspond to a method, a function, a procedure, a subroutine, a subprogram, etc. When a process corresponds to a function, its termination can correspond to a return of the function to the calling function or the main function.

User devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
generating user interfaces to facilitate secure communications between a user device and an authentication system, wherein at least a set of the user interfaces are associated with a unique configuration of interface elements;
generating first feedback data by evaluating the set of the user interfaces against first testing metrics, wherein the first feedback data indicates a first measure of performance of a respective user interface based on the first testing metrics;
identifying a subset of the user interfaces based on the first feedback data;
generating second feedback data by evaluating the subset of the user interfaces against second testing metrics, wherein the second feedback data indicates a second measure of performance of a respective user interface based on the second testing metrics;
identifying a preferred user interface of the subset of the user interfaces based on the second feedback data; and
implementing the preferred user interface for use in secure data flows for network data management.

2. The computer-implemented method of claim 1, wherein the first testing metrics and the second testing metrics are identical.

3. The computer-implemented method of claim 1, wherein the first testing metrics and the second testing metrics are performance vectors configured to evaluate how well the user interfaces perform under certain conditions.

4. The computer-implemented method of claim 1, wherein generating the first feedback data and generating the second feedback data are performed using at least one of automated feedback and human feedback.

5. The computer-implemented method of claim 1, wherein identifying the subset of the user interfaces based on the first feedback data further includes:
generating a new user interface associated with a new configuration of interface elements that is distinct from the set of the user interfaces, wherein the new user interface is included in the subset of the user interfaces.

6. The computer-implemented method of claim 1, wherein a first user interface includes a first interface element in a first position and a second user interface includes the first user interface element in a second position, wherein the first position and the second position are distinct.

7. The computer-implemented method of claim 1, wherein prior to identifying the preferred user interface, the method further comprises:
identifying a second subset of the user interfaces based on the second feedback data, wherein the subset of the user interfaces includes the second subset of the user interfaces; and
generating third feedback data by evaluating the second subset of the user interfaces against third testing metrics, wherein the third feedback data indicates a third measure of performance of a respective user interface based on the third testing metrics.

8. A system comprising:
one or more processors; and
a memory storing instructions that, when executed by the one or more processors, configure the system to:
generate user interfaces to facilitate secure communications between a user device and an authentication system, wherein at least a set of the user interfaces are associated with a unique configuration of interface elements;
generate first feedback data by evaluating the set of the user interfaces against first testing metrics, wherein the first feedback data indicates a first measure of performance of a respective user interface based on the first testing metrics;
identify a subset of the user interfaces based on the first feedback data;
generate second feedback data by evaluating the subset of the user interfaces against second testing metrics, wherein the second feedback data indicates a second measure of performance of a respective user interface based the second testing metrics;
identify a preferred user interface of the subset of the user interfaces based on the second feedback data; and
implement the preferred user interface for use in secure data flows for network data management.

9. The system of claim 8, wherein the first testing metrics and the second testing metrics are identical.

10. The system of claim 8, wherein the first testing metrics and the second testing metrics are performance vectors configured to evaluate how well the user interfaces perform under certain conditions.

11. The system of claim 8, wherein generate the first feedback data and generating the second feedback data are performed using at least one of automated feedback and human feedback.

12. The system of claim 8, wherein identify the subset of the user interfaces based on the first feedback data further includes:
generate a new user interface associated with a new configuration of interface elements that is distinct from the set of the user interfaces, wherein the new user interface is included in the subset of the user interfaces.

13. The system of claim 8, wherein a first user interface includes a first interface element in a first position and a second user interface includes the first user interface element in a second position, wherein the first position and the second position are distinct.

14. The system of claim 8, wherein prior to identifying the preferred user interface, the instructions further configure the system to:
identify a second subset of user interfaces based on the second feedback data, wherein the subset of the user interfaces includes the second subset of the user interfaces; and
generate third feedback data by evaluating the second subset of the user interfaces against third testing metrics, wherein the third feedback data indicates a third measure of performance of a respective user interface based on the third testing metrics.

15. A non-transitory computer-readable storage medium, the computer-readable storage medium including instructions that when executed by a processor, cause the processor to:
generate user interfaces to facilitate secure communications between a user device and an authentication system, wherein at least a set of the user interfaces are associated with a unique configuration of interface elements;
generate first feedback data by evaluating the set of the user interfaces against first testing metrics, wherein the first feedback data indicates a first measure of performance of a respective user interface based on the first testing metrics;
identify a subset of the user interfaces based on the first feedback data;
generate second feedback data by evaluating the subset of the user interfaces against second testing metrics, wherein the second feedback data indicates a second measure of performance of a respective user interface based the second testing metrics;
identify a preferred user interface of the subset of the user interfaces based on the second feedback data; and
implement the preferred user interface for use in secure data flows for network data management.

16. The non-transitory computer-readable medium of claim 15, wherein the first testing metrics and the second testing metrics are performance vectors configured to evaluate how well the user interfaces perform under certain conditions.

17. The non-transitory computer-readable medium of claim 15, wherein generate the first feedback data and generating the second feedback data are performed using at least one of automated feedback and human feedback.

18. The non-transitory computer-readable medium of claim 15, wherein identify the subset of the user interfaces based on the first feedback data further includes:
generate a new user interface associated with a new configuration of interface elements that is distinct from the set of the user interfaces, wherein the new user interface is included in the subset of the user interfaces.

19. The non-transitory computer-readable medium of claim 15, wherein a first user interface includes a first interface element in a first position and a second user interface includes the first user interface element in a second position, wherein the first position and the second position are distinct.

20. The non-transitory computer-readable medium of claim 15, wherein prior to identifying the preferred user interface, the instructions further configure the processor to:
identify a second subset of the user interfaces based on the second feedback data, wherein the subset of the user interfaces includes the second subset of the user interfaces; and
generate third feedback data by evaluating the second subset of the user interfaces against third testing metrics, wherein the third feedback data indicates a third measure of performance of a respective user interface based on the third testing metrics.
